(19) United States
(12) Patent Application Publication
(10) Pub. No.: US 2025/0139993 A1
(43) Pub. Date: May 1, 2025

(54) OCCUPANT INFORMATION ACQUISITION APPARATUS, OCCUPANT INFORMATION ACQUISITION SYSTEM, AND NON-TRANSITORY COMPUTER READABLE MEDIUM

(71) Applicant: NEC Corporation, Minato-ku, Tokyo (JP)

(72) Inventor: Kohei Hijikata, Tokyo (JP)

(73) Assignee: NEC Corporation, Minato-ku, Tokyo (JP)

(21) Appl. No.: 18/835,761

(22) PCT Filed: Mar. 14, 2022
(86) PCT No.: PCT/JP2022/011408

§ 371 Date: Aug. 5, 2024

(51) Int. Cl. G06V 20/59; B60N 2/00; G06V 10/141; G06V 40/16

(52) U.S. Cl. CPC G06V 20/593; B60N 2/0025; G06V 10/141; G06V 40/172

(57) ABSTRACT

An occupant information acquisition apparatus includes riding information acquisition means for acquiring riding information of an occupant on a rear seat of a vehicle from a sensor configured to detect the occupant, imaging condition control means for activating, in an imaging device, a second imaging condition different from a first imaging condition for capturing image data of the occupant on a driver's seat and causing the imaging device to capture image data of the occupant on the rear seat, and image data acquisition means for acquiring the image data captured by the imaging device.

### TECHNICAL FIELD

The present disclosure relates to an occupant information acquisition apparatus, an occupant information acquisition system, an occupant information acquisition method, and a non-transitory computer readable medium.

### BACKGROUND ART

In a cabin of a vehicle such as an automobile, personal authentication of an occupant and ascertaining of a state of the occupant are used for safety and service improvement of the automobile. For example, in order to perform face authentication of an occupant, it is conceivable to attach a camera to a position of a rearview mirror and image the interior. In order to reduce the influence of nighttime or external light, there is also a method of performing imaging by using an infrared camera. In this case, an infrared camera and an infrared light source are required.

Patent Literature 1 discloses a face detection apparatus including a face detection unit that searches for a face of a person from an in-vehicle image obtained by imaging the inside of a vehicle and specifies a face region in which the face of the person is detected. Patent Literature 1 discloses that the face detection unit sets a search region for searching for a face of a person on the basis of a position of a face region, and then searches for the face of the person from an in-vehicle image.

Patent Literature 2 discloses a face detection apparatus that sets a search region in which a face of an occupant is searched for in a captured image acquired from an imaging device that images the occupant in a vehicle, and enlarges the search region in a case where a face detection unit fails to detect the face of the occupant.

Patent Literature 3 discloses an occupant physique determination apparatus including a twist determination unit that determines whether an occupant is in a twisting pose on the basis of a shoulder joint position of the occupant seated in a seating portion in a vehicle and a physique determination unit that determines a physique of the occupant. In a case where the twist determination unit determines that the occupant is in the twisting pose, the physique determination unit invalidates the determination of the physique of the occupant used for the determination.

Patent Literature 4 discloses an occupant detection system including an IR sensor that detects a state of an object and a sensor drive apparatus that changes a position of a detection target region that is a region where the state is detected by the IR sensor.

Patent Literature 5 discloses an occupant monitoring apparatus that acquires a no-shadow image of an upper body of an occupant to be used for controlling various devices of a vehicle and monitors the occupant.

Patent Literature 6 discloses a face recognition apparatus in which an illumination light source is turned on only when a clear captured image cannot be obtained due to the presence of ambient light, insufficient exposure, or the like, and a vehicular user entertainment system using the face recognition apparatus.

Patent Literature 7 discloses a vehicle drive apparatus that can be started when face image data of a driver is collated and matched by a face recognition apparatus that recognizes a driver's face acquired by an imaging camera installed in a vehicle.

### CITATION LIST

### Patent Literature

Patent Literature 1: International Patent Publication No. WO2021/210041

Patent Literature 2: International Patent Publication No. WO2021/192007

Patent Literature 3: Japanese Unexamined Patent Application Publication No. 2021-066276

Patent Literature 4: Japanese Unexamined Patent Application Publication No. 2017-128321

Patent Literature 5: Japanese Unexamined Patent Application Publication No. 2010-111367

Patent Literature 6: Japanese Unexamined Patent Application Publication No. 2008-017227

Patent Literature 7: Japanese Unexamined Patent Application Publication No. 2004-330979

### SUMMARY OF INVENTION

### Technical Problem

In a case where face authentication of each seat in a vehicle cabin is performed, an appropriate face image cannot be acquired at each seat, and the accuracy of the face authentication may deteriorate.

In view of the above-described problems, an object of the present disclosure is to provide an occupant information acquisition apparatus, an occupant information acquisition system, an occupant information acquisition method, and a non-transitory computer readable medium capable of improving accuracy of face authentication.

### Solution to Problem

According to one aspect of the present disclosure, there is provided an occupant information acquisition apparatus including riding information acquisition means for acquiring riding information of an occupant on a rear seat of a vehicle from a sensor configured to detect the occupant; imaging condition control means for activating, in an imaging device, a second imaging condition different from a first imaging condition for capturing image data of the occupant on a driver's seat and causing the imaging device to capture image data of the occupant on the rear seat; and image data acquisition means for acquiring the image data captured by the imaging device.

According to another aspect of the present disclosure, there is provided an occupant information acquisition system including a sensor configured to detect an occupant on a rear seat of a vehicle; an imaging device configured to capture image data of the occupant in the vehicle; and an occupant information acquisition apparatus connected to the sensor and the imaging device via a communication line, in which the occupant information acquisition apparatus includes riding information acquisition means for acquiring riding information of the occupant from the sensor, imaging condition control means for activating, in the imaging device, a second imaging condition different from a first imaging condition for capturing image data of the occupant on a driver's seat and causing the imaging device to capture image data of the occupant on the rear seat, and image data acquisition means for acquiring the image data captured by the imaging device.

According to still another aspect of the present disclosure, there is provided an occupant information acquisition method including acquiring riding information of an occupant on a rear seat of a vehicle from a sensor configured to detect the occupant; activating, in an imaging device, a second imaging condition different from a first imaging condition for capturing image data of the occupant on a driver's seat and causing the imaging device to capture image data of the occupant on the rear seat; and acquiring the image data captured by the imaging device.

According to still another aspect of the present disclosure, there is provided a non-transitory computer readable medium storing an occupant information acquisition program for causing a computer to execute acquiring riding information of an occupant on a rear seat of a vehicle from a sensor configured to detect the occupant; activating, in an imaging device, a second imaging condition different from a first imaging condition for capturing image data of the occupant on a driver's seat and causing the imaging device to capture image data of the occupant on the rear seat; and acquiring the image data captured by the imaging device.

### ADVANTAGEOUS EFFECTS OF INVENTION

According to the present disclosure, it is possible to provide an occupant information acquisition apparatus, an occupant information acquisition system, an occupant information acquisition method, and a non-transitory computer readable medium capable of improving accuracy of face authentication.

### BRIEF DESCRIPTION OF DRAWINGS

FIG. 1 is a configuration diagram exemplifying an occupant information acquisition system according to an outline of an example embodiment.

FIG. 2 is a configuration diagram exemplifying another occupant information acquisition system according to the outline of the example embodiment.

FIG. 3 is a block diagram exemplifying an occupant information acquisition apparatus according to the outline of the example embodiment.

FIG. 4 is a block diagram exemplifying another occupant information acquisition apparatus according to the outline of the example embodiment.

FIG. 5 is a flowchart exemplifying an occupant information acquisition method according to the outline of the example embodiment.

FIG. 6 is a flowchart exemplifying another occupant information acquisition method according to the outline of the example embodiment.

FIG. 7 is a block diagram exemplifying an occupant information acquisition apparatus according to a first example embodiment.

FIG. 8 is a flowchart exemplifying an occupant information acquisition method according to the first example embodiment.

FIG. 9 is a configuration diagram exemplifying imaging conditions in a case of imaging occupants on a driver's seat and a passenger's seat in the occupant information acquisition system according to the first example embodiment.

FIG. 10 is a configuration diagram exemplifying imaging conditions in a case of imaging an occupant on a rear seat in the occupant information acquisition system according to the first example embodiment.

FIG. 11 is a configuration diagram exemplifying imaging conditions in a case of imaging occupants on a driver's seat, a passenger's seat, and a rear seat in the occupant information acquisition system according to the first example embodiment.

FIG. 12 is a configuration diagram exemplifying imaging conditions in a case of imaging occupants on a driver's seat, a passenger's seat, and a rear seat in the occupant information acquisition system according to the first example embodiment.

FIG. 13 is a configuration diagram exemplifying a sensor that detects an occupant on a rear seat in the occupant information acquisition system according to the first example embodiment.

FIG. 14 is a configuration diagram exemplifying a sensor that detects an occupant on a rear seat in the occupant information acquisition system according to the first example embodiment.

FIG. 15 is a configuration diagram exemplifying a sensor that detects an occupant on a rear seat in the occupant information acquisition system according to the first example embodiment.

FIG. 16 is a configuration diagram exemplifying a sensor that detects an occupant on a rear seat in the occupant information acquisition system according to the first example embodiment.

FIG. 17 is a block diagram exemplifying a configuration of a face authentication apparatus in the occupant information acquisition system according to the first example embodiment.

FIG. 18 is a flowchart exemplifying a flow of a face information registration process in the occupant information acquisition system according to the first example embodiment.

FIG. 19 is a flowchart exemplifying a flow of a face authentication process in the occupant information acquisition system according to the first example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated description is omitted as necessary for clarity of description.

### Outline of Example Embodiment

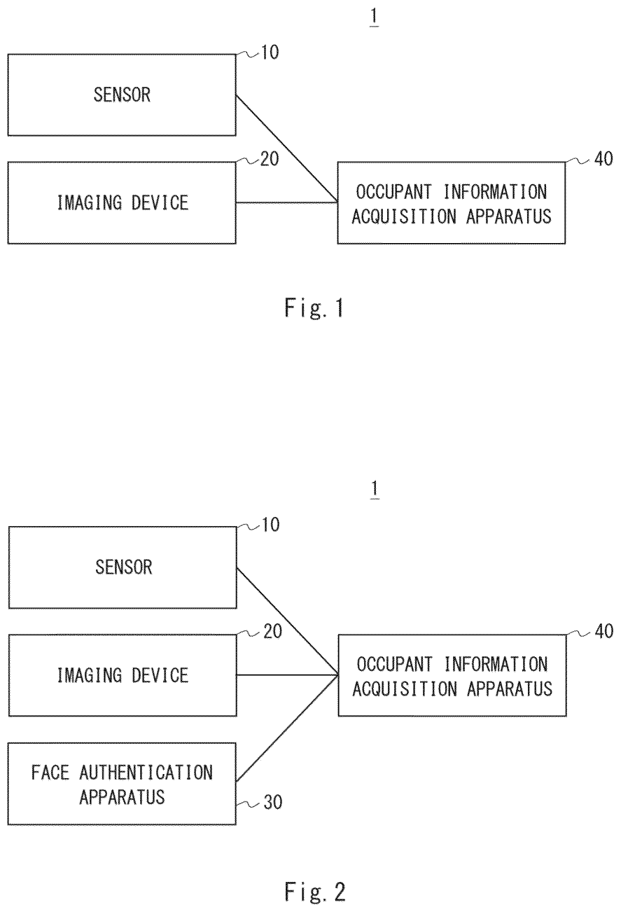

An occupant information acquisition system and an occupant information acquisition apparatus according to an outline of an example embodiment will be described. FIG. 1 is a configuration diagram exemplifying an occupant information acquisition system according to an outline of an example embodiment. As illustrated in FIG. 1, the occupant information acquisition system 1 includes a sensor 10, an imaging device 20, and an occupant information acquisition apparatus 40. FIG. 2 is a configuration diagram exemplifying another occupant information acquisition system according to the outline of the example embodiment. As illustrated in FIG. 2, the occupant information acquisition system I may further include a face authentication apparatus 30. The sensor 10, the imaging device 20, the face authentication apparatus 30, and the occupant information acquisition apparatus 40 have functions as sensor means, imaging means, face authentication means, and information processing means, respectively.

The sensor 10 detects an occupant riding in a vehicle. The sensor 10 may detect an occupant on each seat of the vehicle. For example, the sensor 10 may detect an occupant on a rear seat of the vehicle, or may detect occupants on a driver's seat and a passenger's seat of the vehicle.

The imaging device 20 images an occupant in a vehicle cabin of the vehicle. Specifically, the imaging device 20 captures image data of an occupant in order to perform face authentication of the occupant of the vehicle. The imaging device 20 may capture image data of occupants on a driver's seat and a passenger's seat, or may capture image data of an occupant on a rear seat. When the image data of the occupants on the driver's seat and the passenger's seat is acquired, the imaging device 20 captures the image data of the occupant on the driver's seat under a first imaging condition. When the image data of the occupant on the rear seat is acquired, the imaging device 20 captures the image data of the occupant on the rear seat under a second imaging condition. The first imaging condition and the second imaging condition are different, for example, in conditions at the time of imaging such as an angle of view, a focal point, a gain, and an exposure time at the time of imaging an occupant, and a type and a light amount of a light source.

The face authentication apparatus 30 performs face authentication of an occupant with image data of the face of the occupant.

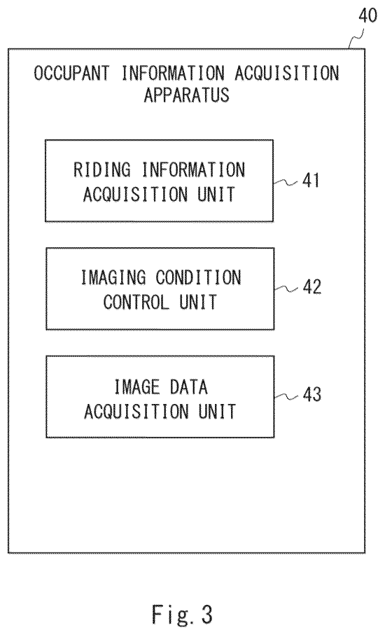

The occupant information acquisition apparatus 40 is connected to the sensor 10, the imaging device 20, and the face authentication apparatus 30 via a communication line capable of transmitting information. FIG. 3 is a block diagram exemplifying the occupant information acquisition apparatus 40 according to the outline of the example embodiment. As illustrated in FIG. 3, the occupant information acquisition apparatus 40 is separated from the occupant information acquisition system 1 as a single unit product.

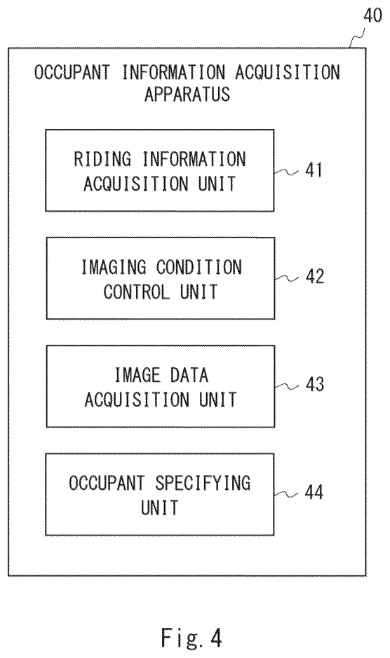

The occupant information acquisition apparatus 40 includes a riding information acquisition unit 41, an imaging condition control unit 42, and an image data acquisition unit 43. FIG. 4 is a block diagram exemplifying another occupant information acquisition apparatus 40 according to the outline of the example embodiment. As illustrated in FIG. 4, the occupant information acquisition apparatus 40 may further include an occupant specifying unit 44. The riding information acquisition unit 41, the imaging condition control unit 42, the image data acquisition unit 43, and the occupant specifying unit 44 have functions as riding information acquisition means, imaging condition control means, image data acquisition means, and occupant specifying means, respectively.

The riding information acquisition unit 41 acquires riding information of the occupant from the sensor 10. For example, the riding information acquisition unit 41 may acquire riding information of occupants from the sensor 10 that detects occupants on the driver's seat and the passenger's seat, or may acquire riding information of an occupant from the sensor 10 that detects an occupant on the rear seat of the vehicle.

The imaging condition control unit 42 controls imaging conditions of the imaging device 20. Specifically, the imaging condition control unit 42 sets the imaging device 20 to a first imaging condition when the imaging device 20 captures image data of the occupants on the driver's seat and the passenger's seat. As a result, the imaging device 20 captures the image data of the occupants on the driver's seat and the passenger's seat under the first imaging condition.

The imaging condition control unit 42 activates the second imaging condition in the imaging device 20 when the imaging device 20 captures the image data of the occupant on the rear seat. The imaging condition control unit 42 causes the imaging device 20 to capture image data of the occupant on the rear seat under a second imaging condition. As described above, when imaging the occupant on the rear seat, the imaging condition control unit 42 activates the second imaging condition different from the first imaging condition for capturing the image data of the occupant on the driver's seat in the imaging device 20. The imaging condition control unit 42 causes the imaging device 20 to capture the image data of the occupant on the rear seat.

The image data acquisition unit 43 acquires the image data captured by the imaging device 20. The occupant specifying unit 44 causes the face authentication apparatus 30 to perform face authentication by using the acquired image data. The occupant specifying unit 44 specifies the occupant from the face authentication of the face authentication apparatus 30.

The occupant information acquisition apparatus 40 described above is, for example, an information processing apparatus such as a personal computer, a server, a mobile terminal, or a tablet terminal. The occupant information acquisition apparatus 40 may include a processor, a memory, a storage device, and a communication apparatus as constituents (not illustrated). The storage device may store processing performed by each constituent of the occupant information acquisition apparatus 40 as a program. The processor may read the program from the storage device into the memory and execute the program. As a result, the processor realizes functions of the riding information acquisition unit 41, the imaging condition control unit 42, the image data acquisition unit 43, the occupant specifying unit 44, and the like. The communication apparatus performs communication necessary for the occupant information acquisition apparatus 40 to perform information processing.

Each constituent of the occupant information acquisition apparatus 40 may be realized by dedicated hardware. Some or all of the constituents may be implemented by general-purpose or dedicated circuitry, a processor, or the like, or a combination thereof. These constituents may be configured with a single chip or may be configured with a plurality of chips connected via a bus. Some or all of the constituents of each apparatus may be implemented by, for example, a combination of the above-described circuit and a program. For example, a central processing unit (CPU), a graphics processing unit (GPU), a field-programmable gate array (FPGA), or a quantum processor (quantum computer control chip) may be used as the processor.

In a case where some or all of the constituents of the occupant information acquisition apparatus 40 are implemented by a plurality of information processing apparatuses, circuits, and the like, the plurality of information processing apparatuses, circuits, and the like may be disposed in a centralized manner or in a distributed manner. For example, the information processing apparatuses, the circuits, and the like may be implemented in the form of a client server system, a cloud computing system, or the like in which they are connected to each other via a communication network. The function of the occupant information acquisition apparatus 40 may be provided in a software as a service (Saas) format.

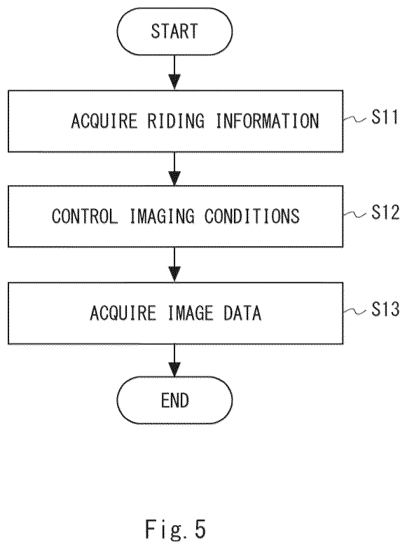

Next, an occupant information acquisition method using the occupant information acquisition apparatus 40 will be described with reference to a flowchart. FIG. 5 is a flowchart exemplifying an occupant information acquisition method according to the outline of the example embodiment. As illustrated in step S11 in FIG. 5, riding information is acquired. For example, the riding information acquisition unit 41 of the occupant information acquisition apparatus 40 acquires the riding information of the occupant from sensor 10 that detects the occupant on the rear seat of the vehicle.

Next, as illustrated in step S12, imaging conditions are controlled. For example, when acquiring image data of the occupant on the rear seat, the imaging condition control unit 42 activates the second imaging condition different from the first imaging condition for capturing image data of the occupant on the driver's seat in the imaging device 20. The imaging condition control unit 42 causes the imaging device 20 to capture image data of the occupant on the rear seat.

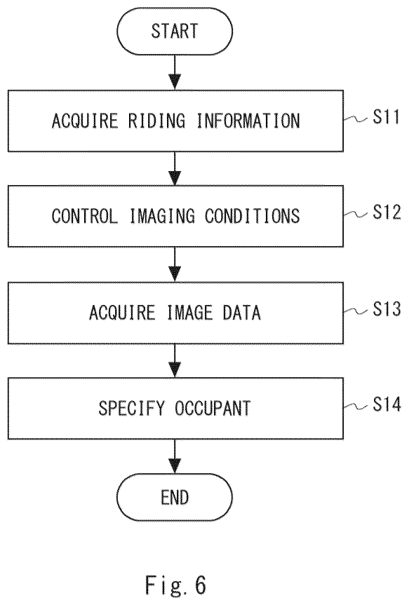

Next, as illustrated in step S13, image data is acquired. For example, the image data acquisition unit 43 acquires the image data captured by the imaging device 20. FIG. 6 is a flowchart exemplifying another occupant information acquisition method according to the outline of the example embodiment. As illustrated in FIG. 6, the occupant information acquisition method may further include step S14. As illustrated in step S14, an occupant is specified. Specifically, the occupant specifying unit 44 causes the face authentication apparatus 30 to perform face authentication by using the acquired image data. The occupant specifying unit 44 specifies the occupant on the basis of an authentication result from the face authentication apparatus 30.

Next, effects of the present example embodiment will be described. The occupant information acquisition system 1 and the occupant information acquisition apparatus 40 according to the present example embodiment activate a second imaging condition different from a first imaging condition for capturing image data of an occupant on a driver's seat in the imaging device 20 in a case of acquiring image data of an occupant on a rear seat. Therefore, image data of a high image can be acquired, and the accuracy of face authentication can be improved. Since the second imaging condition is activated only when the rear seat is imaged, the cost can be reduced.

### First Example Embodiment

Next, an occupant information acquisition system and an occupant information acquisition apparatus according to a first example embodiment will be described. Details of an <occupant information acquisition apparatus>, an <imaging device>, a <sensor>, and a <face authentication apparatus>will be described below.

### <Occupant Information Acquisition Apparatus>

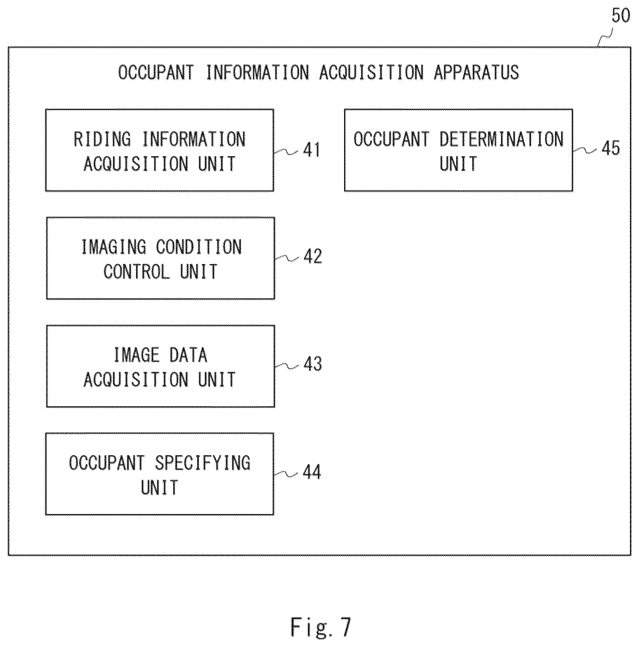

FIG. 7 is a block diagram exemplifying an occupant information acquisition apparatus according to the first example embodiment. As illustrated in FIG. 7, an occupant information acquisition apparatus 50 may further include an occupant determination unit 45. The occupant determination unit 45 has a function as occupant determination means. The occupant determination unit 45 determines whether the riding information acquisition unit 41 has acquired riding information of an occupant on a rear seat. In a case where the occupant determination unit 45 determines that the riding information of the occupant on the rear seat has been acquired by the riding information acquisition unit 41, the imaging condition control unit 42 activates the second imaging condition in the imaging device 20. On the other hand, in a case where the occupant determination unit 45 determines that the riding information of the occupant on the rear seat has not been acquired by the riding information acquisition unit 41, the imaging condition control unit 42 sets the first imaging condition in the imaging device 20.

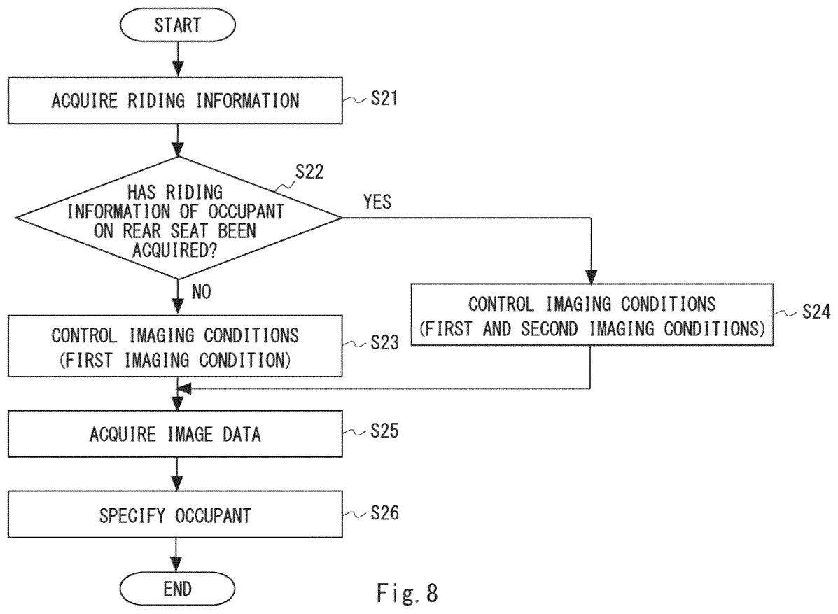

FIG. 8 is a flowchart exemplifying an occupant information acquisition method according to the first example embodiment. As illustrated in step S21 in FIG. 8, riding information is acquired. For example, the riding information acquisition unit 41 of the occupant information acquisition apparatus 40 acquires the riding information of the occupant from sensor 10 that detects the occupant on the rear seat of the vehicle.

Next, as illustrated in step S22, an occupant is determined. For example, the occupant determination unit 45 determines whether the riding information acquisition unit 41 has acquired riding information of an occupant on a rear seat. In a case of NO in which it is determined in step S22 that the riding information of the occupant on the rear seat has not been acquired, the imaging condition control unit 42 sets the first imaging condition in the imaging device 20 as illustrated in step S23. The imaging condition control unit 42 causes the imaging device 20 to capture image data of an occupant on a driver's seat.

On the other hand, in a case of YES in which it is determined in step S22 that the riding information of the occupant on the rear seat has been acquired, the imaging condition control unit 42 sets the first imaging condition in the imaging device 20 as illustrated in step S24. The imaging condition control unit 42 causes the imaging device 20 to capture image data of an occupant on a driver's seat. At the same time, the imaging condition control unit 42 activates the second imaging condition in the imaging device 20. The imaging condition control unit 42 causes the imaging device 20 to capture image data of the occupant on the rear seat.

Next, as illustrated in step S25, image data is acquired. For example, the image data acquisition unit 43 acquires the image data captured by the imaging device 20. In a case where the riding information of the occupant on the rear seat has not been acquired, the image data acquisition unit 43 acquires image data of the occupants on the driver's seat and the passenger's seat. In a case where the riding information of the occupant on the rear seat has been acquired, the image data acquisition unit 43 acquires image data of the occupant on the rear seat in addition to the image data of the occupants on the driver's seat and the passenger's seat.

Next, as illustrated in step S26, an occupant is specified. Specifically, the occupant specifying unit 44 causes the face authentication apparatus 30 to perform face authentication by using the acquired image data. The occupant specifying unit 44 specifies the occupant on the basis of an authentication result from the face authentication apparatus 30. For example, in a case where the riding information of the occupant on the rear seat has not been acquired, the occupant specifying unit 44 causes the face authentication apparatus 30 to perform face authentication by using the image data of the occupants on the driver's seat and the passenger's seat. As a result, the occupant specifying unit 44 specifies the occupants on the driver's seat and the passenger's seat. On the other hand, in a case where the riding information of the occupant on the rear seat has been acquired, the occupant specifying unit 44 causes the face authentication apparatus 30 to perform the face authentication by using the image data of the occupant on the rear seat in addition to the image data of the occupants on the driver's seat and the passenger's seat. As a result, the occupant specifying unit 44 specifies the occupants on the driver's seat, the passenger's seat, and the rear seat. As described above, the occupant information acquisition apparatus 50 can specify the occupants through the face authentication.

### <Imaging Device>

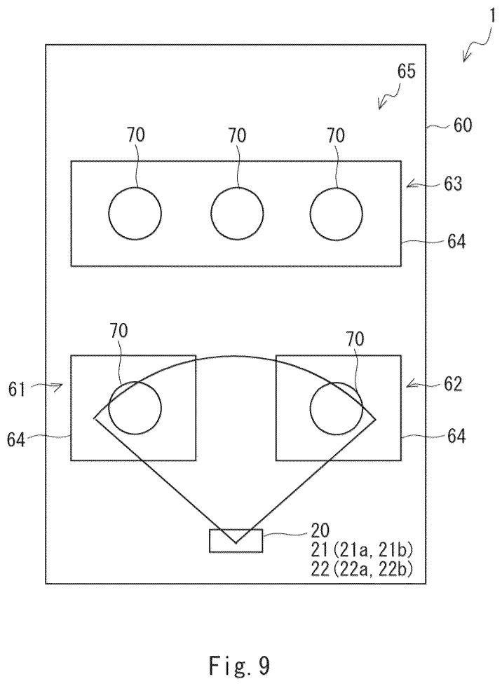

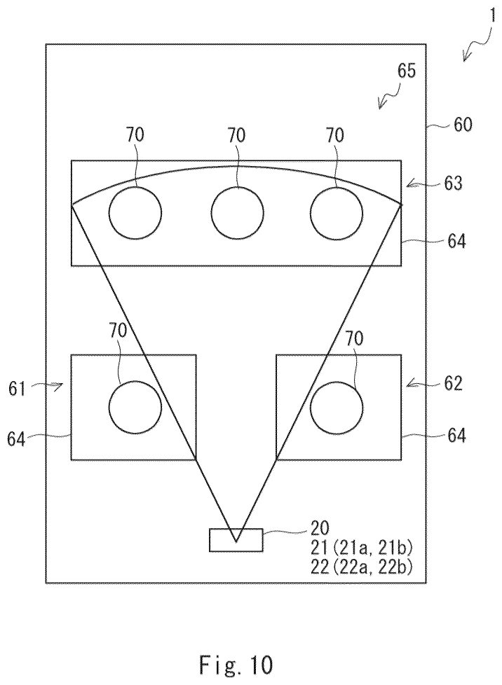

Next, details of the imaging device 20 will be described. FIG. 9 is a configuration diagram exemplifying imaging conditions in a case of imaging occupants on a driver's seat and a passenger's seat in the occupant information acquisition system I according to the first example embodiment. FIG. 10 is a configuration diagram exemplifying imaging conditions in a case of imaging an occupant on a rear seat in the occupant information acquisition system 1 according to the first example embodiment.

As illustrated in FIGS. 9 and 10, the occupant information acquisition system 1 of the present example embodiment images an occupant 70 in an interior 65 of a vehicle 60. The imaging device 20 may include an imaging unit 21 and a light source 22. The imaging unit 21 and the light source 22 have functions as imaging means and light source means, respectively. The imaging unit 21 is, for example, a camera. The imaging unit 21 may be an infrared camera. The light source 22 may be, for example, a white light source or an infrared light source. In a case where an amount of light when the imaging unit 21 images the occupant 70 is insufficient, the light source 22 generates light for illuminating the occupant 70. In a case where an amount of infrared light when the imaging unit 21 images the occupant 70 with the infrared camera is insufficient, the light source 22 generates infrared light.

The imaging device 20 may include the imaging unit 21 disposed in front of a driver's seat 61 and the light source 22 disposed in front of the driver's seat. For example, at least one of the imaging unit 21 and the light source 22 may be disposed at a rearview mirror. Imaging conditions when the imaging device 20 images the occupant 70 riding in the vehicle 60 may be different for each seat of the vehicle 60. For example, the imaging conditions may be different for the driver's seat 61, a passenger's seat 62, and a rear seat 63. The occupant 70 is seated on a seating portion 64 of each seat.

As illustrated in FIG. 9, for example, when the imaging device 20 captures image data of the occupants 70 in the driver's seat 61 and the passenger's seat 62, the imaging condition control unit 42 sets at least one of the imaging unit 21 and the light source 22 as the first imaging condition. For example, during the operation of the occupant information acquisition system 1, the imaging device 20 is usually set to the first imaging condition.

On the other hand, as illustrated in FIG. 10, when the imaging device 20 captures image data of the occupant 70 in the rear seat 63, the imaging condition control unit 42 activates the second imaging condition in at least one of the imaging unit 21 and the light source 22. Specifically, the second imaging condition is not activated in the imaging device 20 until the riding information acquisition unit 41 acquires riding information of the occupant on the rear seat 63 from the sensor 10. When the riding information acquisition unit 41 acquires the riding information of the occupant riding on the rear seat 63 from the sensor 10, the second imaging condition is activated in the imaging device 20. The imaging device 20 may switch from the first imaging condition to the second imaging condition.

The imaging device 20 may include an imaging unit 21a having the first imaging condition and an imaging unit 21b having the second imaging condition. The imaging device 20 may include a light source 22a having the first imaging condition and a light source 22b having the second imaging condition. In this case, when the riding information acquisition unit 41 acquires the riding information of the occupant on the rear seat 63 from the sensor 10, the imaging condition control unit 42 activates at least one of the imaging unit 21b and the light source 22b.

The imaging condition control unit 42 may cause the imaging device 20 to capture the image data of the occupant on the rear seat 63 under the second imaging condition before or after causing the imaging device 20 to capture the image data of the occupant on the driver's seat 61 under the first imaging condition. As described above, the first imaging condition and the second imaging condition may be switched by one imaging device 20.

The imaging condition control unit 42 may cause the imaging device 20 to capture the image data of the occupant on the rear seat 63 under the second imaging condition before, after, or simultaneously with causing the imaging device 20 to capture the image data of the occupant on the driver's seat 61 under the first imaging condition. As described above, the second imaging condition may be activated only when the image data of the occupant on the rear seat 63 is captured.

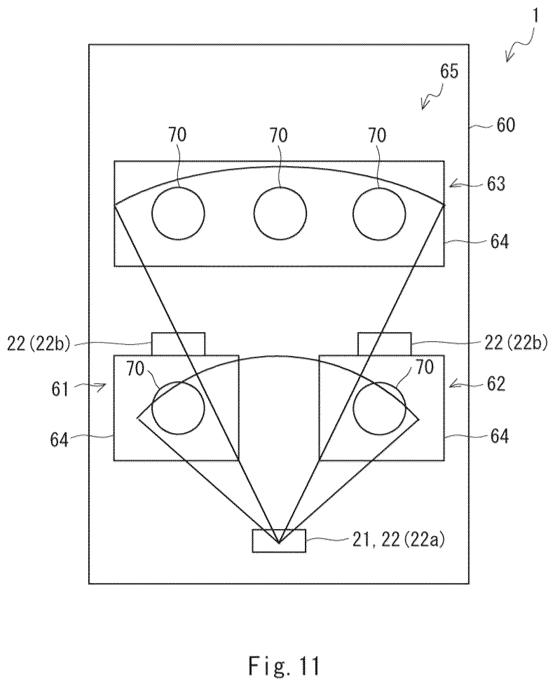

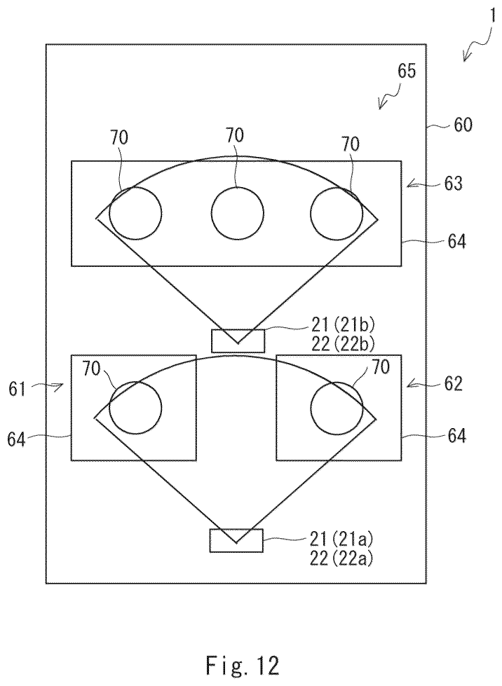

FIGS. 11 and 12 are configuration diagrams exemplifying imaging conditions in a case of imaging the occupants on the driver's seat 61, the passenger's seat 62, and the rear seat 63 in the occupant information acquisition system 1 of the first example embodiment. As illustrated in FIG. 11, the imaging device 20 includes the imaging unit 21 disposed in front of the driver's seat 61, the light source 22a disposed in front of the driver's seat, and the light source 22b disposed behind the driver's seat. For example, the imaging unit 21 is disposed at a rearview mirror. The light source 22a is disposed at the rearview mirror, and the light source 22b is disposed behind the seating portions 64 of the driver's seat 61 and the passenger's seat 62.

As illustrated in FIG. 12, the imaging device 20 includes the imaging unit 21a disposed in front of the driver's seat 61, the light source 22a disposed in front of the driver's seat, the imaging unit 21b disposed behind the driver's seat, and the light source 22b disposed behind the driver's seat. For example, the imaging unit 21a and the light source 22a are disposed at the rearview mirror. The imaging unit 21b and the light source 22b are disposed behind the driver's seat 61 and the passenger's seat 62 between the driver's seat 61 and the passenger's seat 62.

In a case of capturing image data of the occupants on the driver's seat 61 and the passenger's seat 62, the imaging condition control unit 42 sets the first imaging condition in the imaging unit 21a and the light source 22a disposed in front of the driver's seat. On the other hand, in a case of capturing the image data of the occupant on the rear seat 63, the imaging condition control unit 42 activates the second imaging condition in the imaging unit 21b disposed in front of the driver's seat 61 and the light source 22b disposed behind the driver's seat 61.

As described above, the imaging device 20 includes the imaging unit 21a disposed in front of the driver's seat 61 and the light source 22a disposed in front of the driver's seat 61, and includes at least one of the imaging unit 21b different from the imaging unit 21a and the light source 22b different from the light source 22a. The imaging condition control unit 42 activates the second imaging condition in at least one of the imaging unit 21a, the light source 22a, the imaging unit 21b, and the light source 22b.

Note that the positions of the imaging unit 21a, the imaging unit 21b, the light source 22a, and the light source 22b are not limited to the front of the driver's seat, the rear of the driver's seat, the rearview mirror, and the like as long as the occupants on the driver's seat 61, the passenger's seat 62, and the rear seat 63 can be imaged, and may be changed to positions suitable for imaging.

### <Sensor>

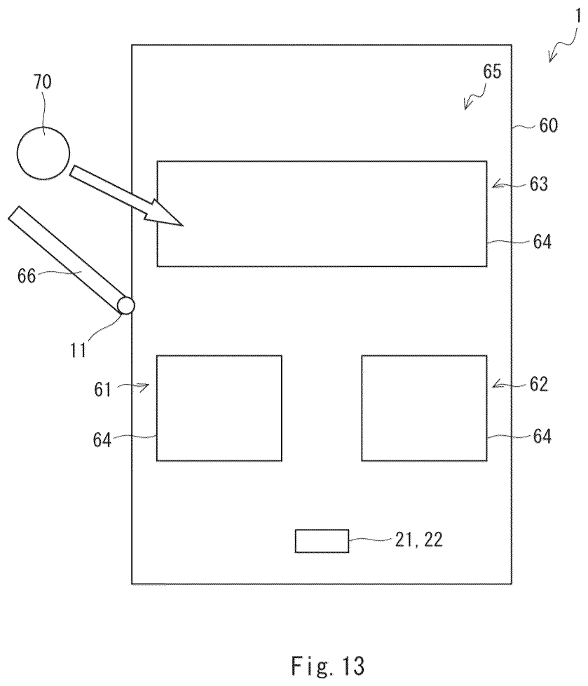

Next, details of the sensor 10 will be described. FIG. 13 is a configuration diagram exemplifying the sensor 10 that detects an occupant on the rear seat 63 in the occupant information acquisition system 1 according to the first example embodiment. As illustrated in FIG. 13, a sensor 11 is disposed on a door 66 of the rear seat 63. The sensor 11 detects the occupant 70 on the rear seat 63 from opening and closing of the door 66 of the rear seat 63. The riding information acquisition unit 41 acquires riding information of the occupant 70 detected by the sensor 11.

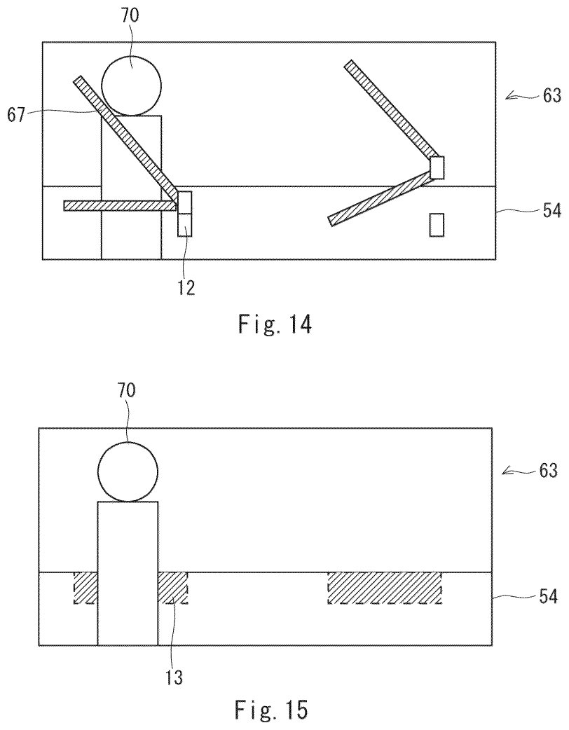

FIG. 14 is a configuration diagram exemplifying the sensor 10 that detects an occupant on the rear seat 63 in the occupant information acquisition system 1 according to the first example embodiment. As illustrated in FIG. 14, a sensor 12 is disposed on a fastener of a seat belt 67 of the rear seat 63. The sensor 12 detects the occupant 70 on the rear seat 63 from opening and closing of the fastener of the seat belt 67 of the rear seat 63. The riding information acquisition unit 41 acquires riding information of the occupant 70 detected by the sensor 12.

FIG. 15 is a configuration diagram exemplifying the sensor 10 that detects an occupant on the rear seat 63 in the occupant information acquisition system 1 according to the first example embodiment. As illustrated in FIG. 15, a sensor 13 is disposed below the seating portion 64 of the rear seat 63. The sensor 13 detects the occupant 70 on the rear seat 63 from a weight applied to the seating portion 64 of the rear seat 63. The riding information acquisition unit 41 acquires riding information of the occupant 70 detected by the sensor 13.

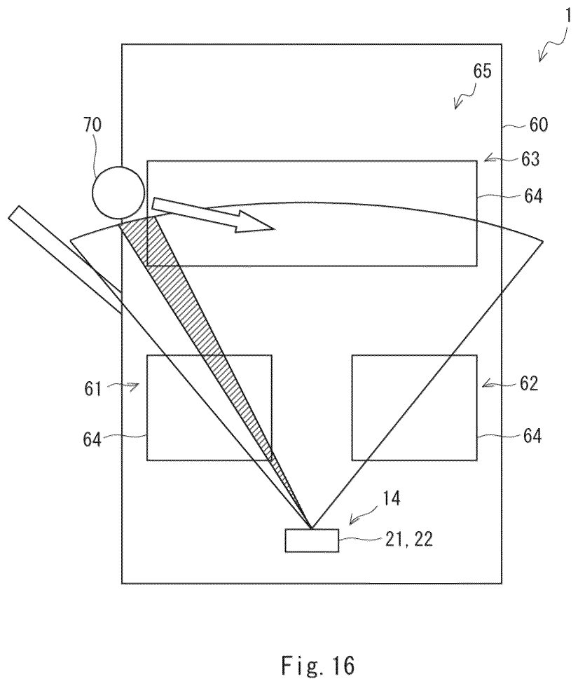

FIG. 16 is a configuration diagram exemplifying the sensor 10 that detects an occupant on the rear seat 63 in the occupant information acquisition system 1 according to the first example embodiment. As illustrated in FIG. 16, a sensor 14 may be the imaging device 20. Specifically, the sensor 14 may be the imaging unit 21. The imaging device 20 that is the sensor 14 detects movement of a moving object on the rear seat 63. The sensor 14 detects the occupant 70 on the rear seat 63 from the movement of the moving object on the rear seat 63. The riding information acquisition unit 41 acquires riding information of the occupant 70 detected by the sensor 13.

In a case where the imaging device 20 functions as a sensor that detects an occupant on the rear seat from the movement of a moving object on the rear seat, it is not necessary to dispose another sensor, and thus, it is possible to reduce the cost. For example, the imaging device 20 may function as a sensor that detects an occupant on the rear seat under the first imaging condition. As a result, when the image data of the occupant on the driver's seat 61 is acquired, the occupant on the rear seat can be detected.

The imaging device 20 may function as a sensor that detects an occupant on the rear seat in a case of an occupant detection condition different from the first imaging condition and the second imaging condition. Since an amount of light can be reduced under the occupant detection condition compared with the first imaging condition and the second imaging condition, the cost can be reduced.

Note that the sensor 10 that detects the occupant 70 on the rear seat 63 is not limited to the above-described sensor. A timing at which the imaging condition control unit 42 activates the second imaging condition is not limited to the time when the riding information acquisition unit 41 acquires the riding information of the occupant on the rear seat 63 from the sensor 10 and the time when the occupant determination unit 45 determines the occupant on the rear seat 63. For example, the timing may be a timing at which the occupant specifying unit 44 receives face authentication failure information transmitted from the face authentication apparatus 30 in a case where the face authentication apparatus 30 fails in the face authentication with the image data of the occupant on the rear seat captured under the first imaging condition.

### <Face Authentication Apparatus>

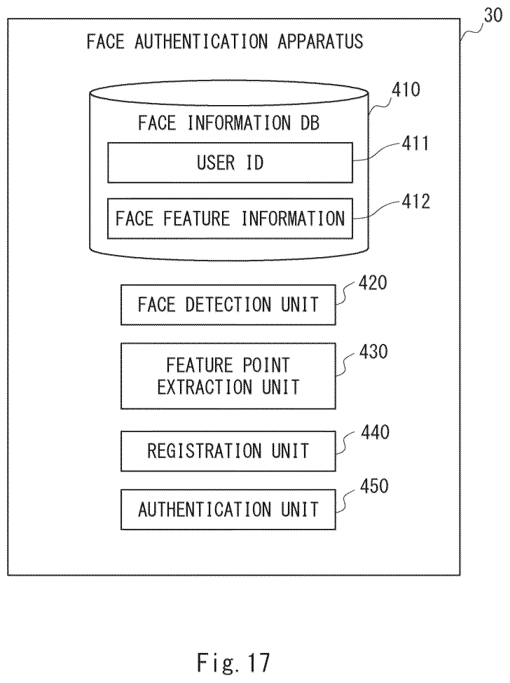

Next, details of the face authentication apparatus 30 will be described. FIG. 17 is a block diagram exemplifying a configuration of a face authentication apparatus 30 in the occupant information acquisition system 1 according to the first example embodiment. As illustrated in FIG. 17, the face authentication apparatus 30 includes a face information DB 410, a face detection unit 420, a feature point extraction unit 430, a registration unit 440, and an authentication unit 450. The face information DB 410, the face detection unit 420, the feature point extraction unit 430, the registration unit 440, and the authentication unit 450 have functions as face information DB means, face detection means, feature point extraction means, registration means, and authentication means, respectively.

The face information DB 410 stores a user ID 411 and face feature information 412 of the user ID in association with each other. The user ID 411 is information for identifying a user, and is, for example, an identification number. The face feature information 412 is a set of feature points extracted from a face image, and is an example of face information. Note that the face authentication apparatus 400 may delete the face feature information 412 in the face feature DB 410 in response to a request from a registered user having the face feature information 412. Alternatively, the face authentication apparatus 400 may delete the face feature information 412 after a lapse of a certain period from registration of the face feature information.

The face detection unit 420 detects a face region included in a registration image for registering face information, and supplies the face region to the feature point extraction unit 430. The feature point extraction unit 430 extracts feature points from the face region detected by the face detection unit 420 and supplies face feature information to the registration unit 440. The feature point extraction unit 430 extracts feature points included in the face image received from the occupant information acquisition apparatus 50, and supplies the face feature information to the authentication unit 450.

The registration unit 440 newly issues the user ID 411 when registering the face feature information. The registration unit 440 registers the issued user ID 411 and the face feature information 412 extracted from the registration image in the face information DB 410 in association with each other. The authentication unit 450 performs face authentication using the face feature information 412. Specifically, the authentication unit 450 collates the face feature information extracted from the face image with the face feature information 412 in the face information DB 410. The authentication unit 450 returns whether or not the pieces of face feature information match to the occupant information acquisition apparatus 50. Whether or not the pieces of face feature information match corresponds to whether or not authentication has succeeded or failed. A case where the pieces of face feature information match (the presence of matching) indicates a case where the degree of matching is equal to or more than a predetermined value.

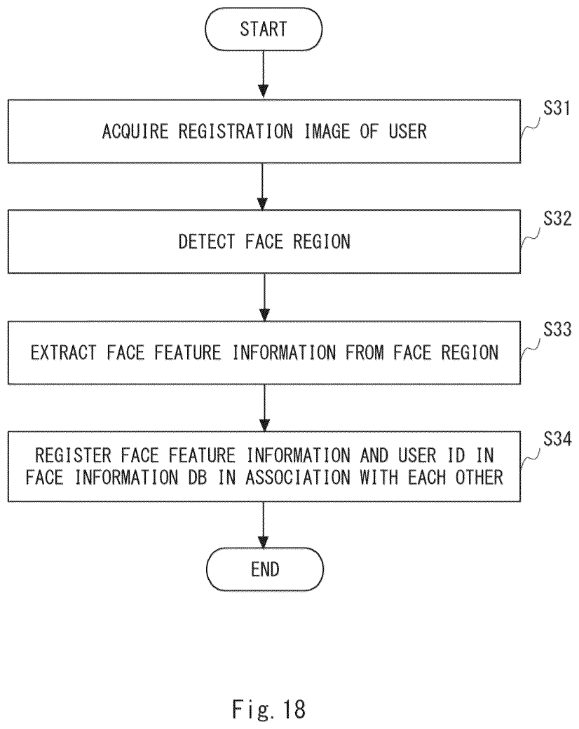

FIG. 18 is a flowchart exemplifying a flow of a face information registration process in the occupant information acquisition system 1 according to the first example embodiment. As illustrated in step S31, first, the face authentication apparatus 30 acquires a registration image of a user U included in a face registration request. For example, the face authentication apparatus 30 receives the face registration request from the occupant information acquisition apparatus 50 that has received a member registration request from a user terminal. The face authentication apparatus 30 is not limited thereto, and may directly receive the face registration request from the user terminal.

Next, as illustrated in step S32, the face detection unit 420 detects a face region included in the registration image. Next, as illustrated in step S33, the feature point extraction unit 430 extracts feature points from the face region detected in step S32, and supplies face feature information to the registration unit 440. Finally, as illustrated in step S34, the registration unit 440 issues the user ID 411, and registers the user ID 411 and the face feature information 412 in the face information DB 410 in association with each other. The face authentication apparatus 400 may receive the face feature information 412 from a face registration request source and register the face feature information 412 in the face information DB 410 in association with the user ID 411.

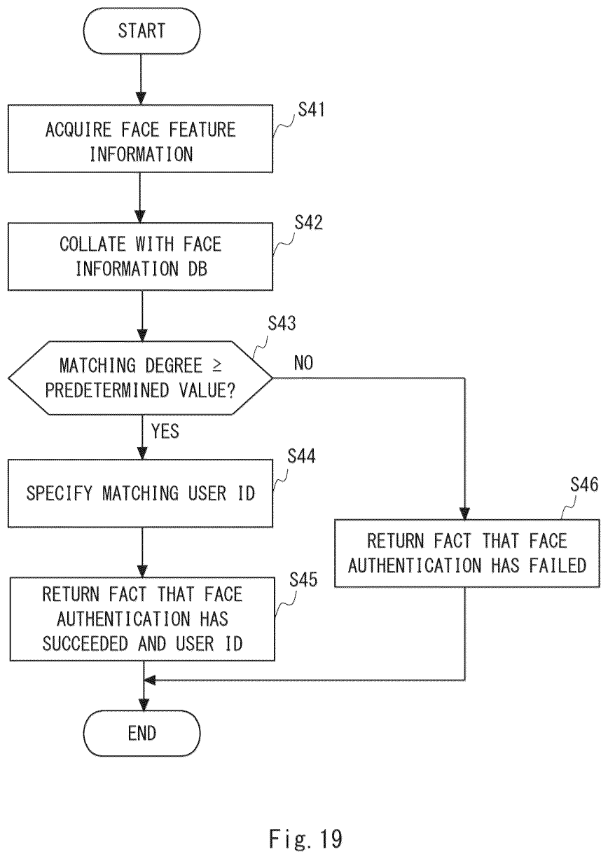

FIG. 19 is a flowchart exemplifying a flow of a face authentication process in the occupant information acquisition system 1 according to the first example embodiment. As illustrated in step S41, first, the feature point extraction unit 430 acquires face feature information for authentication. For example, the face authentication apparatus 30 receives the face authentication request from the occupant information acquisition apparatus 50, and extracts the face feature information from the face image included in the face authentication request as in steps S31 to S33. Alternatively, the face authentication apparatus 30 may receive the face feature information from the occupant information acquisition apparatus 50.

Next, as illustrated in step S42, the authentication unit 450 collates the acquired face feature information with the face feature information 412 in the face information DB 410. Next, as illustrated in step S43, it is determined whether the face features match. Specifically, in a case where the pieces of face feature information match in step S43, that is, in a case of YES in which the matching degree of the face feature information is equal to or more than a predetermined value, as illustrated in step S44, the authentication unit 450 specifies the user ID 411 of the user of which the pieces of face feature information match. As described in step S45, the authentication unit 450 returns the fact that the face authentication has succeeded and the specified user ID411 to the occupant information acquisition apparatus 50 as a face authentication result.

On the other hand, in a case of NO in which there is no matching face feature information in step S43, as illustrated in step S46, the authentication unit 450 returns the fact that the face authentication has failed to the occupant information acquisition apparatus 50 as a face authentication result.

Next, effects of the present example embodiment will be described. The occupant information acquisition system 1 of the present example embodiment can improve the accuracy of face authentication of an occupant in the vehicle 60 by combining the occupant determination for the occupant 70 riding in the vehicle 60 and the face authentication for each seat. Specifically, the riding information acquisition unit 41 acquires riding information of an occupant riding in the vehicle 60 from the sensor 10, and the occupant determination unit 45 determines on which seat in the interior 65 the occupant is seated. As a result, the imaging condition control unit 42 can control the imaging device 20 such that an imaging condition suitable for face authentication for each seat can be obtained, and the image data acquisition unit 43 can acquire image data suitable for face authentication.

The imaging device 20 activates the second imaging condition in a case where image data of an occupant on the rear seat is captured. For example, in a case where the imaging device 20 includes one imaging unit 21 and one light source 22, the first imaging condition of the imaging unit 21 and the light source 22 is stopped, and the second imaging condition is activated. Accordingly, the first imaging condition is switched to the second imaging condition. On the other hand, in a case where the imaging device 20 includes the plurality of imaging units 21a and 21b and the plurality of light sources 22a and 22b, the imaging unit 21b and the light source 22b having the second imaging condition are activated. As described above, since the second imaging condition is activated in a case where image data of an occupant on the rear seat is captured, power consumption can be reduced.

Note that the present disclosure is not limited to the above example embodiment, and can be appropriately changed without departing from the scope. For example, the outline of the example embodiment and each configuration of the first example embodiment may be combined.

Although the face authentication apparatus 30 has the face authentication function in the above-described example embodiment, the occupant information acquisition apparatuses 40 and 50 may have the face authentication function instead of or in addition to the face authentication apparatus 30.

An occupant information acquisition program that causes a computer to read and execute the above-described occupant information acquisition method is also within the scope of the technical idea of the example embodiment. The occupant information acquisition program may be stored in a non-transitory computer readable medium or a tangible storage medium. As an example and not by way of limitation, a computer readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The occupant information acquisition program may be transmitted on a transitory computer readable medium or a communication medium. As an example and not by way of limitation, transitory computer readable or communication media include electrical, optical, acoustic, or other forms of propagated signals.

Some or all of the above-described example embodiments may be described as in the following Supplementary Notes, but are not limited to the following Supplementary Notes.

### Supplementary Note 1

An occupant information acquisition apparatus including:
riding information acquisition means for acquiring riding information of an occupant on a rear seat of a vehicle from a sensor configured to detect the occupant;
imaging condition control means for activating, in an imaging device, a second imaging condition different from a first imaging condition for capturing image data of the occupant on a driver's seat and causing the imaging device to capture image data of the occupant on the rear seat; and
image data acquisition means for acquiring the image data captured by the imaging device.

### Supplementary Note 2

The occupant information acquisition apparatus according to Supplementary Note 1, further including occupant determination means for determining whether the riding information acquisition means has acquired the riding information,
in which the imaging condition control means activates the second imaging condition in the imaging device in a case where the occupant determination means determines that the riding information has been acquired by the riding information acquisition means.

### Supplementary Note 3

The occupant information acquisition apparatus according to Supplementary Note 1 or 2, in which
the imaging device includes
imaging means disposed in front of the driver's seat, and
a light source disposed in front of the driver's seat, and
the imaging condition control means activates the second imaging condition in at least one of the imaging means and the light source.

### Supplementary Note 4

The occupant information acquisition apparatus according to Supplementary Note 3, in which the imaging condition control means causes the imaging device to capture the image data of the occupant on the rear seat under the second imaging condition before or after causing the imaging device to capture the image data of the occupant on the driver's seat under the first imaging condition.

### Supplementary Note 5

The occupant information acquisition apparatus according to Supplementary Note 1 or 2, in which
the imaging device includes
first imaging means disposed in front of the driver's seat,
a first light source disposed in front of the driver's seat, and
at least one of second imaging means different from the first imaging means and a second light source different from the first light source, and
the imaging condition control means activates the second imaging condition in at least one of the first imaging means, the first light source, the second imaging means, and the second light source.

### Supplementary Note 6

The occupant information acquisition apparatus according to Supplementary Note 5, in which
the imaging condition control means causes the imaging device to capture the image data of the occupant on the rear seat under the second imaging condition before, after, or simultaneously with causing the imaging device to capture the image data of the occupant on the driver's seat under the first imaging condition.

### Supplementary Note 7

The occupant information acquisition apparatus according to any one of Supplementary Notes 1 to 6, in which the sensor detects the occupant on the rear seat from opening and closing of a door of the rear seat.

### Supplementary Note 8

The occupant information acquisition apparatus according to any one of Supplementary Notes 1 to 6, in which the sensor detects the occupant on the rear seat from opening and closing of a fastener of a seat belt of the rear seat.

### Supplementary Note 9

The occupant information acquisition apparatus according to any one of Supplementary Notes 1 to 6, in which the sensor detects the occupant on the rear seat from a weight applied to a seating portion of the rear seat.

### Supplementary Note 10

The occupant information acquisition apparatus according to any one of Supplementary Notes 1 to 6, in which the sensor includes the imaging device configured to detect the occupant on the rear seat from movement of a moving object on the rear seat.

### Supplementary Note 11

The occupant information acquisition apparatus according to any one of Supplementary Notes 1 to 10, further including occupant specifying means for causing a face authentication apparatus to perform face authentication by using the acquired image data and specify the occupant.

### Supplementary Note 12

An occupant information acquisition system including:
a sensor configured to detect an occupant on a rear seat of a vehicle;
an imaging device configured to capture image data of the occupant in the vehicle; and
an occupant information acquisition apparatus connected to the sensor and the imaging device via a communication line, in which
the occupant information acquisition apparatus includes
riding information acquisition means for acquiring riding information of the occupant from the sensor,
imaging condition control means for activating, in the imaging device, a second imaging condition different from a first imaging condition for capturing image data of the occupant on a driver's seat and causing the imaging device to capture image data of the occupant on the rear seat, and
image data acquisition means for acquiring the image data captured by the imaging device.

### Supplementary Note 13

The occupant information acquisition system according to Supplementary Note 12, in which
the occupant information acquisition apparatus further includes occupant determination means for determining whether the riding information acquisition means has acquired the riding information, and
the imaging condition control means activates the second imaging condition in the imaging device in a case where the occupant determination means determines that the riding information has been acquired by the riding information acquisition means.

### Supplementary Note 14

The occupant information acquisition system according to Supplementary Note 12 or 13, in which
the imaging device includes
imaging means disposed in front of the driver's seat, and
a light source disposed in front of the driver's seat, and
the imaging condition control means activates the second imaging condition in at least one of the imaging means and the light source.

### Supplementary Note 15

The occupant information acquisition system according to Supplementary Note 14, in which the imaging condition control means causes the imaging device to capture the image data of the occupant on the rear seat under the second imaging condition before or after causing the imaging device to capture the image data of the occupant on the driver's seat under the first imaging condition.

### Supplementary Note 16

The occupant information acquisition system according to Supplementary Note 12 or 13, in which
the imaging device includes
first imaging means disposed in front of the driver's seat,
a first light source disposed in front of the driver's seat, and
at least one of second imaging means different from the first imaging means and a second light source different from the first light source, and
the imaging condition control means activates the second imaging condition in at least one of the first imaging means, the first light source, the second imaging means, and the second light source.

### Supplementary Note 17

The occupant information acquisition system according to Supplementary Note 16, in which the imaging condition control means causes the imaging device to capture the image data of the occupant on the rear seat under the second imaging condition before, after, or simultaneously with causing the imaging device to capture the image data of the occupant on the driver's seat under the first imaging condition.

### Supplementary Note 18

The occupant information acquisition system according to any one of Supplementary Notes 12 to 17, in which the sensor detects the occupant on the rear seat from opening and closing of a door of the rear seat.

### Supplementary Note 19

The occupant information acquisition system according to any one of Supplementary Notes 12 to 17, in which the sensor detects the occupant on the rear seat from opening and closing of a fastener of a seat belt of the rear seat.

### Supplementary Note 20

The occupant information acquisition system according to any one of Supplementary Notes 12 to 17, in which the sensor detects the occupant on the rear seat from a weight applied to a seating portion of the rear seat.

### Supplementary Note 21

The occupant information acquisition system according to any one of Supplementary Notes 12 to 17, in which the sensor includes the imaging device configured to detect the occupant on the rear seat from movement of a moving object on the rear seat.

### Supplementary Note 22

The occupant information acquisition system according to any one of Supplementary Notes 12 to 21, further including a face authentication apparatus configured to perform face authentication by using the image data,
in which the occupant information acquisition apparatus further includes occupant specifying means for causing the face authentication apparatus to perform face authentication by using the acquired image data and specify the occupant.

### Supplementary Note 23

An occupant information acquisition method including:
acquiring riding information of an occupant on a rear seat of a vehicle from a sensor configured to detect the occupant;
activating, in an imaging device, a second imaging condition different from a first imaging condition for capturing image data of the occupant on a driver's seat and causing the imaging device to capture image data of the occupant on the rear seat; and
acquiring the image data captured by the imaging device.

### Supplementary Note 24

The occupant information acquisition method according to Supplementary Note 23, further including:
determining whether the riding information has been acquired; and
activating the second imaging condition in the imaging device in a case where it is determined that the riding information has been acquired.

### Supplementary Note 25

The occupant information acquisition method according to Supplementary Note 23 or 24, in which
the imaging device includes
imaging means disposed in front of the driver's seat, and
a light source disposed in front of the driver's seat, and
the second imaging condition is activated in at least one of the imaging means and the light source.

### Supplementary Note 26

The occupant information acquisition method according to Supplementary Note 25, further including causing the imaging device to capture the image data of the occupant on the rear seat under the second imaging condition before or after causing the imaging device to capture the image data of the occupant on the driver's seat under the first imaging condition.

### Supplementary Note 27

The occupant information acquisition method according to Supplementary Note 23 or 24, in which
the imaging device includes
first imaging means disposed in front of the driver's seat,
a first light source disposed in front of the driver's seat, and
at least one of second imaging means different from the first imaging means and a second light source different from the first light source, and
the second imaging condition is activated in at least one of the first imaging means, the first light source, the second imaging means, and the second light source.

### Supplementary Note 28

The occupant information acquisition method according to Supplementary Note 27, further including causing the imaging device to capture the image data of the occupant on the rear seat under the second imaging condition before, after, or simultaneously with causing the imaging device to capture the image data of the occupant on the driver's seat under the first imaging condition.

### Supplementary Note 29

The occupant information acquisition method according to any one of Supplementary Notes 23 to 28, in which the sensor detects the occupant on the rear seat from opening and closing of a door of the rear seat.

### Supplementary Note 30

The occupant information acquisition method according to any one of Supplementary Notes 23 to 28, in which the sensor detects the occupant on the rear seat from opening and closing of a fastener of a seat belt of the rear seat.

### Supplementary Note 31

The occupant information acquisition method according to any one of Supplementary Notes 23 to 28, in which the sensor detects the occupant on the rear seat from a weight applied to a seating portion of the rear seat.

### Supplementary Note 32

The occupant information acquisition method according to any one of Supplementary Notes 23 to 28, in which the sensor includes the imaging device configured to detect the occupant on the rear seat from movement of a moving object on the rear seat.

### Supplementary Note 33

The occupant information acquisition method according to any one of Supplementary Notes 23 to 32, further including causing a face authentication apparatus to perform face authentication by using the acquired image data and specify the occupant.

### Supplementary Note 34

A non-transitory computer readable medium storing an occupant information acquisition program for causing a computer to execute:
acquiring riding information of an occupant on a rear seat of a vehicle from a sensor configured to detect the occupant;
activating, in an imaging device, a second imaging condition different from a first imaging condition for capturing image data of the occupant on a driver's seat and causing the imaging device to capture image data of the occupant on the rear seat; and
acquiring the image data captured by the imaging device.

### Supplementary Note 35

The non-transitory computer readable medium storing the occupant information acquisition program according to Supplementary Note 34, for causing the computer to further execute:
determining whether the riding information has been acquired; and
activating the second imaging condition in the imaging device in a case where it is determined that the riding information has been acquired.

### Supplementary Note 36

The non-transitory computer readable medium storing the occupant information acquisition program according to Supplementary Note 34 or 35, in which
the imaging device includes
imaging means disposed in front of the driver's seat, and
a light source disposed in front of the driver's seat, and
the second imaging condition is activated in at least one of the imaging means and the light source.

### Supplementary Note 37

The non-transitory computer readable medium storing the occupant information acquisition program according to Supplementary Note 36, for causing the computer to further execute causing the imaging device to capture the image data of the occupant on the rear seat under the second imaging condition before or after causing the imaging device to capture the image data of the occupant on the driver's seat under the first imaging condition.

### Supplementary Note 38

The non-transitory computer readable medium storing the occupant information acquisition program according to Supplementary Note 34 or 35, in which
the imaging device includes
first imaging means disposed in front of the driver's seat,
a first light source disposed in front of the driver's seat, and
at least one of second imaging means different from the first imaging means and a second light source different from the first light source, and
the second imaging condition is activated in at least one of the first imaging means, the first light source, the second imaging means, and the second light source.

### Supplementary Note 39

The non-transitory computer readable medium storing the occupant information acquisition program according to Supplementary Note 38, for causing the computer to further execute causing the imaging device to capture the image data of the occupant on the rear seat under the second imaging condition before, after, or simultaneously with causing the imaging device to capture the image data of the occupant on the driver's seat under the first imaging condition.

### Supplementary Note 40

The non-transitory computer readable medium storing the occupant information acquisition program according to any one of Supplementary Notes 34 to 39, in which the sensor detects the occupant on the rear seat from opening and closing of a door of the rear seat.

### Supplementary Note 41

The non-transitory computer readable medium storing the occupant information acquisition program according to any one of Supplementary Notes 34 to 39, in which the sensor detects the occupant on the rear seat from opening and closing of a fastener of a seat belt of the rear seat.

### Supplementary Note 42

The non-transitory computer readable medium storing the occupant information acquisition program according to any one of Supplementary Notes 34 to 39, in which the sensor detects the occupant on the rear seat from a weight applied to a seating portion of the rear seat.

### Supplementary Note 43

The non-transitory computer readable medium storing the occupant information acquisition program according to any one of Supplementary Notes 34 to 39, in which the sensor includes the imaging device configured to detect the occupant on the rear seat from movement of a moving object on the rear seat.

### Supplementary Note 44

The non-transitory computer readable medium storing the occupant information acquisition program according to any one of Supplementary Notes 34 to 43, for causing the computer to further execute causing a face authentication apparatus to perform face authentication by using the acquired image data and specify the occupant.

### REFERENCE SIGNS LIST

1 OCCUPANT INFORMATION ACQUISITION SYSTEM
10, 11, 12, 13, 14 SENSOR
20 IMAGING DEVICE
21, 21a, 21b IMAGING UNIT
22, 22a, 22b LIGHT SOURCE
30 FACE AUTHENTICATION APPARATUS
40, 50 OCCUPANT INFORMATION ACQUISITION APPARATUS
41 RIDING INFORMATION ACQUISITION UNIT
42 IMAGING CONDITION CONTROL UNIT
43 IMAGE DATA ACQUISITION UNIT
44 OCCUPANT SPECIFYING UNIT
45 OCCUPANT DETERMINATION UNIT
60 VEHICLE
61 DRIVER'S SEAT
62 PASSENGER'S SEAT
63 REAR SEAT
64 SEATING PORTION
65 INTERIOR
66 DOOR
67 SEAT BELT
70 OCCUPANT
410 FACE INFORMATION DB
411 USER ID
412 FACE FEATURE INFORMATION
420 FACE DETECTION UNIT
430 FEATURE POINT EXTRACTION UNIT
440 REGISTRATION UNIT
450 AUTHENTICATION UNIT

What is claimed is:

1. An occupant information acquisition apparatus comprising:
riding information acquisition unit configured to acquire riding information of an occupant on a rear seat of a vehicle from a sensor configured to detect the occupant;
imaging condition control unit configured to activate, in an imaging device, a second imaging condition different from a first imaging condition for capturing image data of the occupant on a driver's seat and cause the imaging device to capture image data of the occupant on the rear seat; and
image data acquisition unit configured to acquire the image data captured by the imaging device.

2. The occupant information acquisition apparatus according to claim 1, further comprising occupant determination unit configured to determine whether the riding information acquisition unit has acquired the riding information,
wherein the imaging condition control unit activates the second imaging condition in the imaging device in a case where the occupant determination unit determines that the riding information has been acquired by the riding information acquisition unit.

3. The occupant information acquisition apparatus according to claim 1, wherein
the imaging device includes
imaging unit disposed in front of the driver's seat, and
a light source disposed in front of the driver's seat, and
the imaging condition control unit activates the second imaging condition in at least one of the imaging unit and the light source.

4. The occupant information acquisition apparatus according to claim 3, wherein the imaging condition control unit causes the imaging device to capture the image data of the occupant on the rear seat under the second imaging condition before or after causing the imaging device to capture the image data of the occupant on the driver's seat under the first imaging condition.

5. The occupant information acquisition apparatus according to claim 1, wherein
the imaging device includes
first imaging unit disposed in front of the driver's seat,
a first light source disposed in front of the driver's seat, and
at least one of second imaging unit different from the first imaging unit and a second light source different from the first light source, and
the imaging condition control unit activates the second imaging condition in at least one of the first imaging unit, the first light source, the second imaging unit, and the second light source.

6. The occupant information acquisition apparatus according to claim 5, wherein
the imaging condition control unit causes the imaging device to capture the image data of the occupant on the rear seat under the second imaging condition before, after, or simultaneously with causing the imaging device to capture the image data of the occupant on the driver's seat under the first imaging condition.

7. The occupant information acquisition apparatus according claim 1, wherein the sensor detects the occupant on the rear seat from opening and closing of a door of the rear seat.

8. The occupant information acquisition apparatus according to claim 1, wherein the sensor detects the occupant on the rear seat from opening and closing of a fastener of a seat belt of the rear seat.

9. The occupant information acquisition apparatus according to claim 1, wherein the sensor detects the occupant on the rear seat from a weight applied to a seating portion of the rear seat.

10. The occupant information acquisition apparatus according to claim 1, wherein the sensor includes the imaging device configured to detect the occupant on the rear seat from movement of a moving object on the rear seat.

11. The occupant information acquisition apparatus according to claim 1, further comprising occupant specifying unit configured to cause a face authentication apparatus to perform face authentication by using the acquired image data and specify the occupant.

12. An occupant information acquisition system comprising:
a sensor configured to detect an occupant on a rear seat of a vehicle;
an imaging device configured to capture image data of the occupant in the vehicle; and
an occupant information acquisition apparatus connected to the sensor and the imaging device via a communication line, wherein
the occupant information acquisition apparatus includes
riding information acquisition unit configured to acquire riding information of the occupant from the sensor,
imaging condition control unit configured to activate, in the imaging device, a second imaging condition different from a first imaging condition for capturing image data of the occupant on a driver's seat and cause the imaging device to capture image data of the occupant on the rear seat, and
image data acquisition unit configured to acquire the image data captured by the imaging device.

13. The occupant information acquisition system according to claim 12, wherein
the occupant information acquisition apparatus further includes occupant determination unit configured to determine whether the riding information acquisition unit has acquired the riding information, and
the imaging condition control unit activates the second imaging condition in the imaging device in a case where the occupant determination unit determines that the riding information has been acquired by the riding information acquisition unit.

14. The occupant information acquisition system according to claim 12, wherein
the imaging device includes
imaging unit disposed in front of the driver's seat, and
a light source disposed in front of the driver's seat, and
the imaging condition control unit activates the second imaging condition in at least one of the imaging unit and the light source.

15. The occupant information acquisition system according to claim 14, wherein the imaging condition control unit causes the imaging device to capture the image data of the occupant on the rear seat under the second imaging condition before or after causing the imaging device to capture the image data of the occupant on the driver's seat under the first imaging condition.

16. The occupant information acquisition system according to claim 12, wherein
the imaging device includes
first imaging unit disposed in front of the driver's seat,
a first light source disposed in front of the driver's seat, and
at least one of second imaging unit different from the first imaging unit and a second light source different from the first light source, and
the imaging condition control unit activates the second imaging condition in at least one of the first imaging unit, the first light source, the second imaging unit, and the second light source.

17. The occupant information acquisition system according to claim 16, wherein the imaging condition control unit causes the imaging device to capture the image data of the occupant on the rear seat under the second imaging condition before, after, or simultaneously with causing the imaging device to capture the image data of the occupant on the driver's seat under the first imaging condition.

18. The occupant information acquisition system according to claim 12, wherein the sensor detects the occupant on the rear seat from opening and closing of a door of the rear seat.

19. The occupant information acquisition system according to claim 12, wherein the sensor detects the occupant on the rear seat from opening and closing of a fastener of a seat belt of the rear seat.

20-33. (canceled)

34. A non-transitory computer readable medium storing an occupant information acquisition program for causing a computer to execute:
acquiring riding information of an occupant on a rear seat of a vehicle from a sensor configured to detect the occupant;
activating, in an imaging device, a second imaging condition different from a first imaging condition for capturing image data of the occupant on a driver's seat and causing the imaging device to capture image data of the occupant on the rear seat; and
acquiring the image data captured by the imaging device.

35-44. (canceled)
